(19) United States
(12) Patent Application Publication
(10) Pub. No.: US 2004/0241044 A1
(43) Pub. Date: Dec. 2, 2004

(54) System for processing sample plates with built-in electronic memory for high throughput sample processing and a processing method

(76) Inventor: Vladimir Mordekhay, Menlo Park, CA (US)

Correspondence Address: Vladimir Mordekhay, c/o V. Balter, 1045 Lassen Drive, Menlo Park, CA, 94025, US

(21) Appl. No.: 10/706,011

(22) Filed: Nov. 10, 2003

Related U.S. Application Data
(60) Provisional application No. 60/474,399, filed on Jun. 2, 2003.

(51) Int. Cl. G01N 35/00

(52) U.S. Cl. 422/65; 422/67; 422/102

(57) ABSTRACT

A sample plate processing system of the invention in its simplest version consists of a sample deposition station with a data input/output unit and a sample processing station for processing and/or analyzing samples carried by the sample plates. The sample processing station is also equipped with data input/output unit. Both data input/output units interacts with an electronic memory permanently built into each sample plate for loading information into any sample plate which is processed by the stations for or for retrieving information from the aforementioned plate at any current moment of the process. The aforementioned information may contain records of the events history and the current status of the samples and the respective sample plates.

### CROSS-REFERENCE TO RELATED APPLICATIONS

The present patent application is supported by U.S. Provisional Patent Application No. 60/474,399 filed on Jun. 2, 2003 by the same applicant.

### FIELD OF THE INVENTION

The present invention relates to the field of chemistry, analytical chemistry and biochemistry, and in particular to the devices and methods for high throughput sample handling, processing and analyzing. More specifically, the invention relates to a system for processing sample plates with built-in electronic memory for high throughput sample processing and a processing method. In particular, the invention also relates to the construction and structure of sample plates with built-in electronic memory.

### PRIOR ART AND DISADVANTAGE OF THE PRIOR ART

In a modern biochemical lab, in order to achieve higher throughput and productivity, it is common to process simultaneously a plurality of samples. In this case, multiple samples are commonly delivered to a substrate (called a sample plate) with multiple sample holding locations. For example, liquid samples are often processed in a standard 384 positions sample plate. This device is available commercially and consists of 384 wells incorporated into a single plastic body to retain multiple samples (for example, Cole Palmer, Inc. USA, model EW-01929-40). Another example of the processing plate or filtering plate, is available from 3M Inc, Minnesota, USA (model #6060, 96-well Empore Filter Plate). In this plate, the multiple samples are loaded and removed from the same sample filtering plate. On this 96-sample filtering or sample cleaning plate, each well is equipped with an absorbing material, and the bottom of the sample plate is open. Commonly the sample is loaded into this filtering sample plate to perform sample purification or separation. Depending on the sample and absorbent material natures, the sample can be retained on the absorbent material or can be eluted into another standard sample plate located under the separation sample plate.

Another example of the prior-art device is a flat metal plate separated into individual regions (typically 96 or 384) that is used for matrix assisted laser ionization technique. The sample is deposited on the plate in a liquid form. After the sample dries, the plate is transferred into a mass spectrometer for the composition analysis. This device is also available commercially, for example, from Mass Tech Inc, MD, USA.

Yet, another example of the device can be a glass plate that has a number of spots that have selected reactivity to the specific chemicals. This plate can be exposed to a solution that has to be analyzed. As a result of the specific reactivity on each spot specific chemicals from the analyzed solution will or will not react to the different spots on the plate. Also, because of this reaction, each spot can change its optical properties (for example, it can lose or obtain a fluorescent chemical group from the die-labeled sample). To read the information from this plate it is placed into a fluorescent optical spectrometer to obtain information on each spot. For example, Agilent technologies, Inc, USA, manufactures a DNA micro array chip and the optical scanning device (DNA Microarray Scanner, Model G2565BA) to analyze the DNA chip.

In all of the above cases the multiple-sample storage and processing devices can be called biochemical chips, and it is quite common to use attached (or engraved) bar code labels to track the individual devices and the associated data. The bar code method of tracking for the biochemical devices is limited to the amount of information that it can deliver, thus usually requiring to maintain a different set of more complete records on the samples and the applied processes that are referenced by the bar code number. These records can be easily distributed between different computers, sample processing stations, and operators lab books making it difficult to insure the integrity of the records as well as their consistency. It may be also difficult to generate error-free final reports while performing high throughput analysis.

It is also common that biochemical chips have to be transferred from one processing station to another (for example from sample deposition station to incubating station or analyzing station). The sequence of these processes is commonly performed by the operator and is subject to a human error as well as its documentation requires an extra effort from the operator. With bar code labels, it is also difficult to change or modify label information dynamically during chip processing.

It is recognized that it is possible to use a magnetic tape storage device attached to the chemical biochip along with the bar code labels, however this type of memory is quite delicate and somewhat unreliable especially in the environment of chemical labs.

In order to eliminate the above disadvantages of the prior art, the applicant has developed a system of sample-plate carriers disclosed in pending U.S. patent application Ser. No. 10/624,399 filed on Jul. 21, 2003. According to the principle of the aforementioned invention, biochemical chips (hereinafter referred to as sample plates) with samples are inserted into sample plate carriers, which are used for handling the sample plates with mechanical grippers of the sample plate handling mechanism. Such a mechanism may comprise a mechanical arm of a separately installed industrial robot or a gripper of a carrier handling mechanism attached to a mass spectrometer. The use of sample plate carriers prevents direct contact of the grippers with sample plates and thus protects the samples and the sample plates from contamination or damage.

Sample plate carriers disclosed in aforementioned U.S. patent application Ser. No. 10/624,399 are provided with built-in memory elements for inputting/outputting information relating to the samples, sample plates, or sample carriers. Such information may comprise description of the samples, description of the test procedure, description of all other events occurred with a specific sample plate or sample plate carrier, etc.

The system of plates with carriers is convenient and advantageous for operations with a relatively limited number of samples and sample plates.

However, in those applications that involve creation of sample banks required for generation of large-volume data bases, the use of intermediate elements, such as sample plate carriers, may become inconvenient and economically unjustifiable. This is because the carriers dictate the use of large storage cassettes. Furthermore, since the information about specific sample plates is stored in the memory elements, which are physically separated from the sample plates and are located on specific sample plate carriers, these two items, i.e., the specific sample plate and the specific sample carrier, have preferably to be bound to each other. It is understood that when these two items are physically separated, the information about the samples and sample plates, e.g., process history, can be lost. If one needs to obtain the information about a specific sample on a specific sample plate, he/she needs to have an access to the aforementioned specific sample carrier, to be more precise, to the memory element of the sample plate carrier. This is not always convenient since the sample plates and carriers are physically separable and therefore an extra caution is needed for tracing the location of both the carriers and of the sample plates. Furthermore, the sample carriers themselves are relatively complicated devices that occupy an addition space and increase the cost of the operations and of sample plate handling system as a whole.

### OBJECTS AND SUMMARY OF THE INVENTION

It is an object of the present invention to provide a system for processing sample plates with built-in electronic memory for high throughput sample processing. It is a further object to provide a sample plate, for use in conjunction with the aforementioned system, with a non-removable electronic memory device that insures data integrity. Another object is to provide aforementioned sample plate with a built-in memory device suitable for creating sample banks required for generation of large-volume data bases. It is another object to provide a sample plate of the aforementioned type, which is simple in construction, convenient in use, and is economically justifiable. A further object is to provide a sample plate having means for reliably storing data about the samples and their treatments along with the samples themselves in a single-unit device. A further object of the invention is to provide the aforementioned sample plate suitable for MALDI mass spectrometry, Raman spectrometry, and optical spectrometry, in particular for analysis of genes and proteins with accumulation of large-volume information in the data base of a system associated with a sample data bank. Still another object is to provide the aforementioned sample plate with a memory device in the form of a smart biochip device having an electronic non-volatile re-recordable memory device. Still another object is to provide the aforementioned sample plate with a memory device in the form of a memory stick. Still another object is to provide the aforementioned sample plate with a memory device equipped with electronic memory for recording information or for location of the information on external computers. It is another object to provide a method for using the aforementioned sample plates with built-in memory in various real-time high throughput analysis systems with dynamically modified programs. It is another object to provide a method for using the aforementioned sample plates in sample analysis and processing systems with interactive dialog between the memory unit of the sample plate and the memory units of the processing stations for dynamical change of the programs depends on the results of the current analysis. It is another object of the invention to provide a security device attached to the sample plate that would prevent unauthorized usage of the sample plate on standard equipment.

A sample plate processing system of the invention in its simplest version consists of a sample deposition station with a data input/output unit and a sample processing station for processing and/or analyzing samples carried by the sample plates. The sample processing station is also equipped with data input/output unit. Both data input/output units interacts with an electronic memory permanently built into each sample plate for loading information into any sample plate which is processed by the stations for or for retrieving information from the aforementioned plate at any current moment of the process. The aforementioned information may contain records of the events history and the current status of the samples and the respective sample plates.

Each sample plate of the system has a memory device that is permanently attached to the plate and cannot be separated therefrom during storage and processing. The memory device may incorporate a microprocessor and store information about the samples, processes, history of treatment, etc. Since the crucial information is stored directly on the sample plate and transferred to appropriate data storage and processing units concurrently with physical transfer of the sample plates, this information can be utilized for making decisions on current and subsequent processes. A dynamically modified program can be also be recorded to the sample plate to alternate or enhance initial processing program prerecorded in the memory device. Different chemical sample treatment and analyzing processes can be implemented on the sample plate, depending on the final sample processing objective. These treatment and analysis can be represented (including but not limiting to) by the following processes: thin layer chromatographic separation, 2D gel electrophoresis, 1D gel electrophoresis, capillary electrophoresis, liquid chromatography, filtration, affinity sample trapping, multiple nozzle delivery systems, substrates for mass spectrometry, multiple wells devices for liquid storage or archiving. The invention also relates to a method for using the aforementioned sample plates with built-in memory in various real-time high throughput analysis systems with dynamically modified programs. The method of the invention makes it possible to use the sample plates with memory in sample analysis and processing systems with interactive dialog between the memory unit of the sample plate and the memory units of the processing stations for dynamical change of the programs depends on the results of the current analysis.

### BRIEF DESCRIPTION OF THE DRAWINGS

FIG. 1A is a three-dimensional front-side view of the sample plate made in accordance with one embodiment of the present invention.

FIG. 1B is a three-dimensional back-side view of the sample plate of FIG. 1.

FIG. 2 shows a schematic structure of a system of the invention for processing memory-containing sample plates.

FIG. 3A shows the device of the second embodiment of the present invention viewed from the front side.

FIG. 3B shows the device of the second embodiment of the present invention viewed from the back side.

FIG. 3C shows the electronic memory device of the second embodiment of the present invention.

FIG. 4A shows the device of the third embodiment of the present invention viewed from the front side.

FIG. 4B shows the device of the third embodiment of the present invention viewed from the back side.

FIG. 5 shows the device of the fourth embodiment of the present invention.

FIG. 6 shows the device of the fifth embodiment of the present invention.

FIG. 7 shows the device of the sixth embodiment of the present invention.

FIG. 8 shows an arrangement of a sample-plate processing system in accordance with another embodiment of the present invention.

FIG. 9 shows the device of the seventh embodiment of the present invention.

FIG. 10 shows an embodiment of a sample plate, which in addition to a memory unit with electrical contacts has a built-in electronic memory having wireless connection to the input/output stations.

### DETAILED DESCRIPTION OF THE INVENTION

For better understanding the system of the invention, it would be advantageous first to consider in detail the structure and functions of memory-carrying sample plates processed by the invented system.

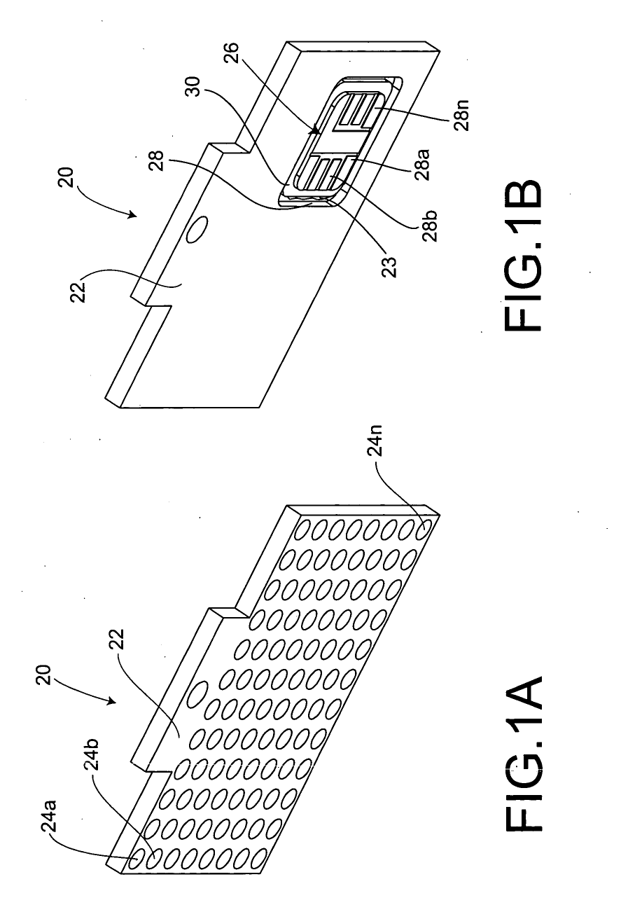

A sample plate with a memory element made in accordance with one embodiment of the present invention is shown in FIGS. 1A and 1B, where FIG. 1A is a three-dimensional front-side view of the sample plate made in accordance with one embodiment and FIG. 1B is a three-dimensional back-side view of the sample plate.

As can be seen from the drawings, a sample plate 20 of the invention, e.g., for matrix assisted laser desorption ionization (MALDI) mass spectrometry consists of a solid body plate 22 divided into individual sample plate wells by the engraved circles 24a, 24b, . . . 24n and an electronic memory device 26 (hereinafter referred to as memory device) for storing information. The samples for analysis are permanently attached to the sample plates. What is meant in the context of the present invention under the term “permanently attached samples” is that during analysis the samples are fixed in certain areas of the sample plates. Depending on the type of the analysis, the samples can be either destructed or non-destructed. If necessary, after analysis the samples can be removed, e.g., by washing out.

The memory device 26 has a plurality of individual electrical contacts 28a, 28b, . . . 28n for powering the device and for interfacing of the memory device with external data inputting/outputting devices. Although eight electrical contacts are shown in FIG. 1B, their number may be different. The memory device 26 can be a commercially available “smart chip” device that is commonly used in banking cards, telephone cards, and the like. Smart cards are secure, compact and intelligent data carriers. Though they lack screens and keyboards, smart cards should be regarded as specialized computers capable of processing, storing, and safeguarding thousands of bytes of data. Similar in size and shape to plastic credit cards, smart cards with electrical contacts have a thin metallic plate just above center line on one side of the card. Beneath this dime-sized plate is an integrated circuit (IC) chip containing a central processing unit (CPU), random access memory (RAM) and non-volatile data storage. Data stored in the smart card's microchip can be accessed only through the chip operating system (COS), providing a high level of data security. This security takes the form of passwords that allow a user to access parts of the IC chip's memory or encryption/decryption measures, which translate the bytes stored in memory into information. According to the invention, security means comprise a security information inputted into the non-volatile data storage and consisting of at least one password. The function can compare inputted passwords to see if they satisfy the function criteria.

The International Standards Organization (ISO) has developed a standard (ISO 7816) for integrated-circuit cards with electrical contacts. This standard defines the physical dimensions of smart cards and their resistance to static electricity, electromagnetic radiation and bending forces. It incorporates other ISO standards that establish the location, as options, of the card's magnetic stripe and embossed data. Most smart cards have eight electrical contacts (as shown in FIG. 1B), but only five have been defined by ISO 7816 and must be active.

A typical smart card contains a chip operating system (COS), file directory structure and “mask” of preprogrammed instructions. These vary from one manufacturer to another and, sometimes, from one card to another within the same vendor's line of products. There is no standard COS for smart cards and read/write devices. To assure an application can operate with products from multiple vendors, a software program must translate application commands and functions into language specific to each card and its COS. This program, which is logically positioned between the application and the COS, is called an application programming interface, or API.

Interoperability does not happen by accident with smart cards; it must be planned and programmed. Because an API can translate between smart cards and read/write devices from multiple vendors, an API is critical to the migration from paper-based methods to a system of interactive electronic documents based on smart cards. Smart cards are produced by various manufacturers, such as Atmel (California), Dallas Semiconductor (Texas), Hitachi Semiconductor (Japan), and many others.

The memory device 26 can be inserted into a recess 28 formed in the solid body of plate 22 and can be fixed in the recess by an appropriate adhesive 23 or by other means. The memory device 26 is isolated from the solid body plate 22 by an insulating plate 30.

The solid body plate 22 may have a geometrical form and dimensions to be compatible with a specific analysis system or apparatus, e.g., with Mass Tech Inc. (MD, USA) atmospheric pressure laser assisted ionization apparatus.

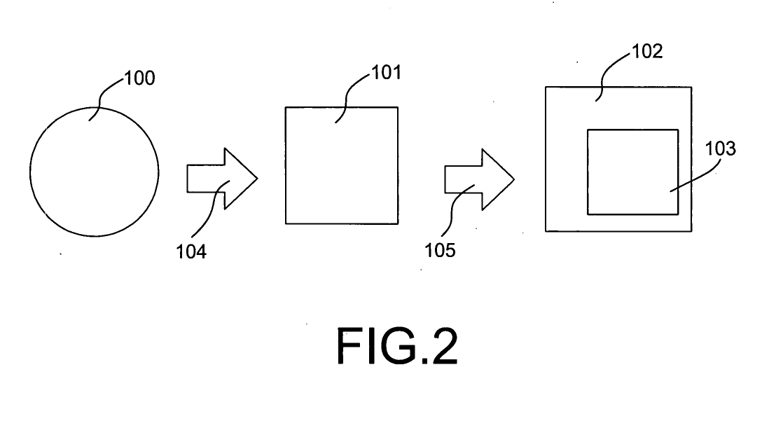

FIG. 2 shows an example of a system of the invention for sample plates of the type described above. The system may have different arrangements and the one shown in FIG. 2 consists of an input station 100 for loading information into sample plates, a sample plate loading station 101 for physically loading samples into sample plates in accordance with the aforementioned information inputted into the memory of plates, and a sample analyzer station 102 that contains an analyzing unit 103, e.g., a mass spectrometer. Loading of the liquid samples can be carried out, e.g., with the use of an automatic loading unit such as HTS PAL produced by CTC Analytics AG (Germany). 2. This unit can be used for loading the sample plates with samples and sample processing chemicals, e.g., dilution solvent. The station can maintain the samples at a permament temperature. At the station 102 the sample can be analyzed, e.g., by a sample partially destructive analysis such as atmospheric pressure MALDI technique with a LCQ Deca XP Plus mass spectrometer operating with the use of the AP MALDI ion source (OPTON-30013) from Thermo Finnigan Co., Inc. The stations 100, 101, and 102 are equipped with standard data input/output units. In other cases, the sample may be analyzed by non-destructive methods such as Raman and infrared Microspectroscopy, e.g., with the use the LabRam IR spectrometric system produced by Jobin Yvon Inc., NJ, USA. Another analyzing technique is laser-induced fluorescent spectroscopy of samples on the sample plates of the invention. This technical can be performed, e.g., by means of GeneChip Scanner 3000 produced by Affymetrix, Inc., CA, USA.

In the embodiment illustrated in FIG. 1B, the station 101 records into the memory device 26 (FIG. 1B) the primary information about the sample/samples as well as the date and time of the sample preparation. The station 102 records the information on time of the analysis. It can also record analysis information such as positive sample identifications, the name of the sample files or even crucial processed data for the samples. If necessary, the station 100 may be used for writing into the memory device 26 (FIG. 1B) of the sample plate 20 the specific information in advance for further use by the automated system 101 and by the process information for loading the sample analyzing system 102. In this case, the memory device 26 is first loaded at the programming station 100 with information on the tasks that have to be performed subsequently in time by sample preparation station 101 and by the analyzing station 102.

According to invention, the information flow which is illustrated by arrows 104 and 105, coincides with physical movements of the sample plate 20 from station to station, since the information is actually stored in the memory device 26 directly on the sample plate 20 (FIGS. 1A and 1B). In other words, the sample plate of the invention is suitable for use in sample analysis and processing systems with interactive dialog between the memory unit of the sample plate and the memory units of the processing stations for dynamical change of the programs depending on the results of the current analysis.

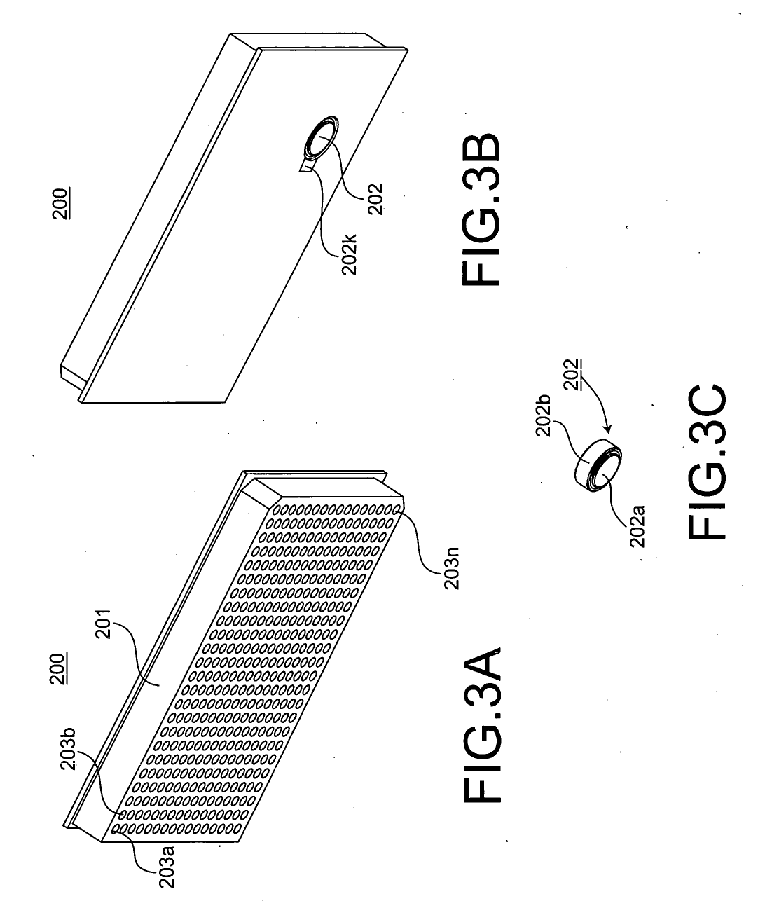

A sample plate made in accordance with a second embodiment of the invention is shown in FIGS. 3A and 3B, where FIG. 3A is a three-dimensional front-view side of the sample plate, and FIG. 3B is a back-side view of the sample plate of FIG. 3A. The sample plate 200 of this embodiment consists of plate 201 manufactured out of plastic with multiple wells 203a, 203b, . . . . 203n for filling with liquid samples. The plate is equipped with pressed-in I-button-type non-volatile rewritable electronic memory device 202 of the type produced by Dallas Semiconductor Inc, USA (see FIG. 3C). More specifically, the memory device 202 has a shape of a button with one flat side 202a of the button being a signal contact and the cylindrical sidewall 202b being an earth contact. As shown in FIG. 3b, a radial contact tab 202k, which is connected to the earth contact 202b of the memory device 202, is exposed to the outer surface of the sample plate 200 for access to the memory device from a connector of the external data input/output device, such as input/out units of the stations 100, 101 in the system of the invention shown in FIG. 2.

It should be noted that according to the invention the memory device 202 is permanently attached to the sample plate 200 so that it cannot be disconnected from the plate. Here and hereinafter, the term “permanently attached” means that the memory device cannot be disconnected from the body of the sample plate without the use of mechanical tools. In the specific embodiment of FIG. 3B such permanent attachment is not seen visually as it is provided due to press fit of the memory device 202 in the opening of the sample plate 200. The sample plate 200 can be used as a disposable device. For the purpose of confidentiality of the information stored in the memory device, the latter contains an identification code that is matched only to stations of the analysis system allowed for the use of a specific sample plate. If the sample plate is discarded, unauthorized persons will not be able to retrieve the information. This feature is especially important for person identification analysis of DNA samples stored in data banks.

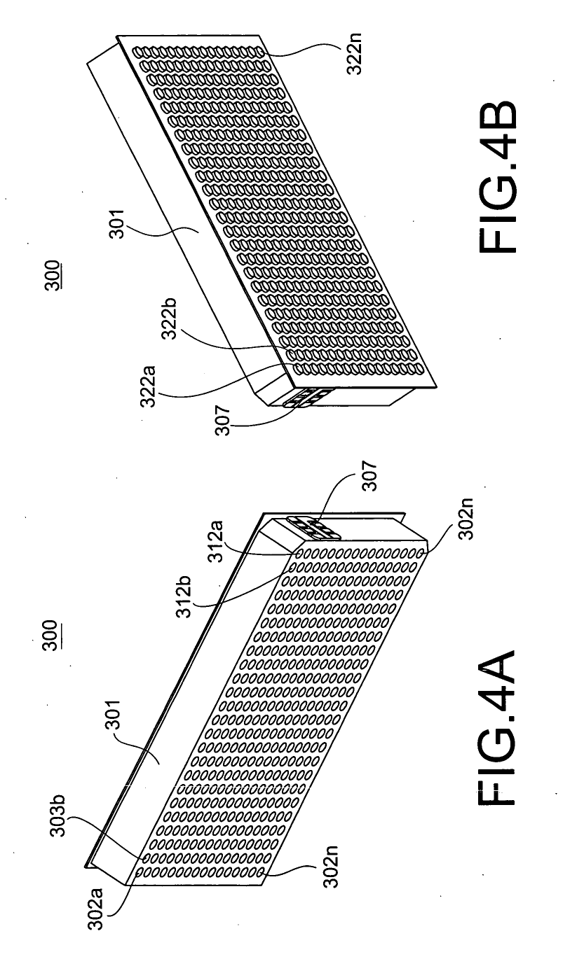

FIG. 4A and FIG. 4B are three-dimensional front-side and rear-side views of a sample plate 300 according to a third embodiment of the invention. The sample plate 300 comprises a sample cleaning or purification device 301. The device 300 comprises a plate 301 made, e.g., of polypropylene, with a plurality of channels filled with chromatographic cartridges 302a, 303b, . . . 302n. Each channel has an entrance opening, such as openings 312a, 312b, . . . 312n, for sample delivery and exit opening 32a, 322b, . . . 322n for the sample discharge. Similar to the previous embodiment, the sample cleaning device 300 incorporates a memory device 307. An example of a sample cleaning operation could be so-called solid-phase extraction (SPE) by 3M Company for the cleaning samples with the Empore Extraction Disk Plates. The sample purification process consists of three steps: 1) loading the samples into the cells of the sample plate on the station 101 that may comprise, e.g., a liquid sample delivery unit; 2) washing the sample with the washing solution at the same unit 101; and 3) eluting the samples with an eluting solution also at the station 101 (http://www.3m.com/empore/Library/Plates/Filter/instr3.htm).

The electronic memory device 307 can be preloaded with instructions on which sample and which solvents have to be applied to each or all of the chromatographic cartridges to provide desired sample treatment.

The eluted purified sample produced by passing samples through the device 300 (FIGS. 4A and 4B) can be loaded to the sample plate 200 of the second embodiment (FIGS. 3A, 3B, and 3C). in this case, transfer of samples can be accompanied by transfer of the information stored in the memory device 307 (FIGS. 4A, 4b) to the memory device 202 of the sample plate 200.

The memory device 307 is also permanently attached to the sample plate 300 so that it cannot be disconnected from the plate, e.g., by adhesive (not shown). The memory device 307 stores the identification code that allows the use of the sample plate 300 only for authorized users, so that the sample plate 300 can be discarded without a risk of access to the information by unauthorized persons.

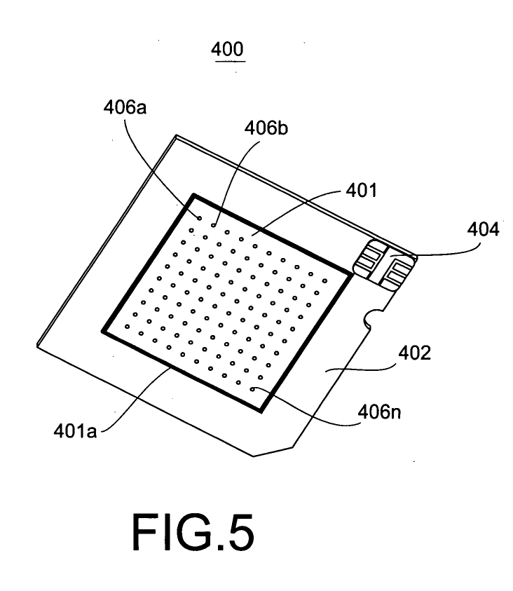

FIG. 5 shows a sample plate according to a fourth embodiment of the present invention. In the forth embodiment, a sample plate 400 of the present invention can be a set of nanospray nozzles 406a, 406b, . . . 406n micro-machined into a silicon wafer 401 permanently embedded into a holding plate 402, e.g., by an epoxy adhesive 401a. The sample plate 400 is also equipped with a memory device 404 mounted directly on the holding plate 402. In contrast to the sample carriers of aforementioned U.S. patent application Ser. No. 624,399 filed on Jul. 21, 2003, the holding plate 402 is permanently connected to the silicon sample plate 401 with samples, e.g., by adhesive, so that the memory device 404 is always accompanies the sample plate 400. The memory device 404 may store information, e.g., about the samples, treatment and analysis processes, etc. As in the previous embodiments, the memory device 404 may contain the identification code.

The samples are preferably transferred to the spraying nozzles 406a, 406b, . . . 406n (FIG. 5) from the device 200 (FIGS. 3A to 3C) by a robotic loading station, such as produced by Advion Inc, NY, USA, model Nanomate 100. Such a robotic station may be incorporated into the aforementioned analyzing station 102 (FIG. 2) with a mass spectrometer such as LCQ Deca XP Plus from Thermo Finnigan Co., Inc.

In this case, according to the invention the results of the analysis can also be recorded in the memory device 202 of the sample plate 200 which also can be used for sample storage within Nanomate 100 sample loading station. This information can be used to decide on future sample processing including but not limiting to sample archiving or additional sample treatment or analysis.

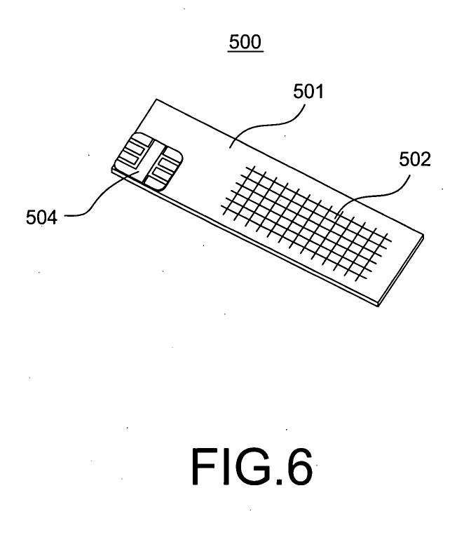

FIG. 6 shows a sample plate according to a fifth embodiment of the present invention. In the fifth embodiment, a sample plate 500 may comprise a light-transparent material such glass or quartz slide 501 with a predeposited array of active spots 502 that possess chemical affinity to specific samples. The sample plate or smart chemical biochip 500 is also provided with a memory device 504 of the same type as in the first embodiment (FIGS. 1A, 1B), which is permanently attached to the glass slide 501. The memory device 504 can be loaded with crucial information on the sample, deposited spots, results of the analysis, e.g., obtained by fluorescent spectroscopy technique by a scanning device (such as model—DNA Microarray Scanner, Model G2565BA, Agilent Technologies, Calif., USA), or the like. Such an optical microarray reader may represent the aforementioned data analysis unit 103 incorporated into the sample analyzing station 102.

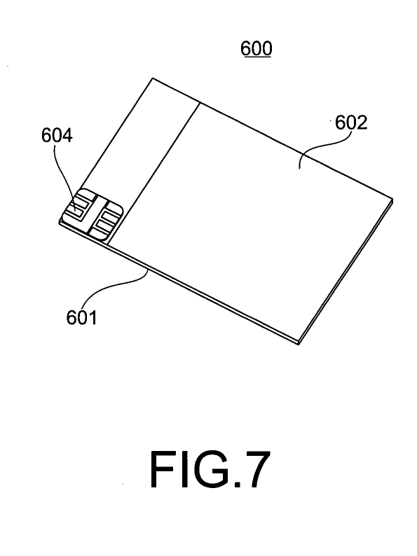

FIG. 7 shows a sample plate of the sixth embodiment of the present invention. In the sixth embodiment a sample plate 600 may comprise a thin-layer chromatography slide 601 equipped with a memory device 604 of the same type as in the first embodiment (FIGS. 1A-1C). Samples are loaded on an active chromatography layer 602 as is well known in the art.

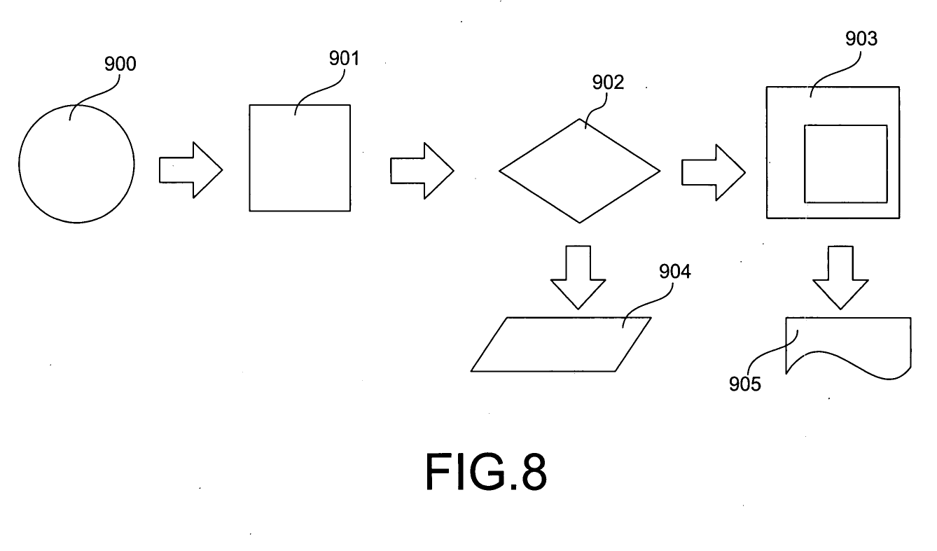

FIG. 8 illustrates another arrangement of the sample plate processing system in accordance with the present invention, which is suitable for processing, e.g., the sample plate 600 of FIG. 7. The system consists of a computer-controlled information input/output data station 900, a sample loading station 901, a sample-plate screening and distribution station 902, and an analytical station 903, e.g., a mass spectrometer. Reference numeral 904 designates a sample plate recycling container, and 905 designates a sample plate storage. The arrows in FIG. 8 show the path of the sample plates through the system.

At station 900, the memory device 604 of the sample plate 600 (FIG. 7) can be loaded with detailed information on the type of the analysis to perform on subsequent stations (FIG. 8). Then sample plates are transferred to the next station either by the robotic device or by a human operator. When the plate 600 arrives to the combined optical reader/sample screening device and the sample deposition station 901, this information is inputted to the station 901 from the memory device 604 of thre sample plate 600. For example, for analysis of a specific drug, station 901 may have information that positive sample identification will correspond to darker regions on the separating layer that is located at a specified distance from the original sample deposition spot.

For all positive samples, this information can be sent from the optical reader 901 back to the memory device 604 of the sample plate 600. At a station 902, this information can be obtained from memory device 604 of the sample plate 600, and a decision can be made at the station 902 either to dispose the sample plate 600 to a recycle container 904 or to send it for conformation analysis to a mass spectrometer station 903. After completing the conformation analysis by station 903, the sample plate 600 can be transferred to an archive 905.

The arrows in FIG. 8 illustrate both the information flow and physical movements of the sample plate between the processing stations. It is recognized, that the decision-making station 902 can be either a part of other sample processing stations that suggests the operator the subsequent desirable processing steps for the sample plate 600 or it can be a fully automated stand along robotic device. It is recognized that according to the invention the decision on the next process for the sample plate 600 can be actually generated within memory device of the sample plate by providing the memory device 604 with a microprocessor unit.

Thus, it has been shown that the invention provides a sample plate and a method that makes the sample plate suitable for use in sample analysis and processing systems with interactive dialog between the memory unit of the sample plate and the memory units of the processing stations for dynamical change of the programs depending on the results of the current analysis.

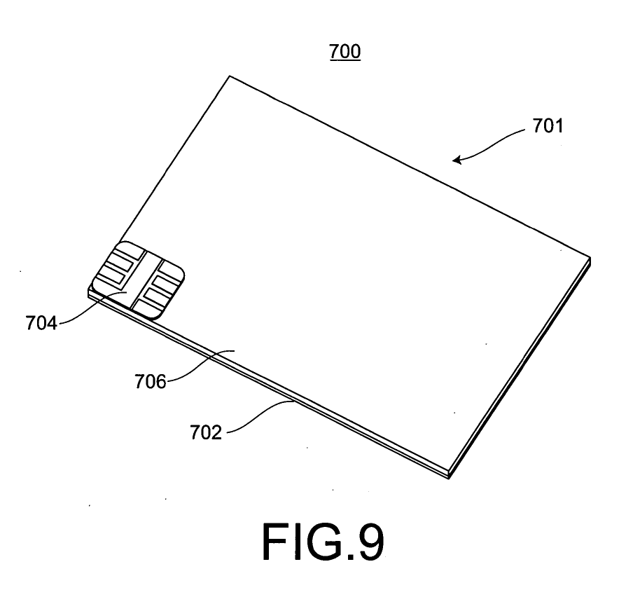

FIG. 9 shows a sample plate of the seventh embodiment of the present invention. In the seventh embodiment, a sample plate 700 may comprise a gel electrophoresis slide 701 for electrophoretic separation equipped with a memory device 704 of the type described with reference to the first embodiment of the invention (FIGS. 1A, 1B, and 1C). Samples are loaded into a gel layer 702 in a manner known in the art, and the memory device 704 is loaded with information for transfer to an optical reader device that is similar to device 901 of FIG. 8. To achieve the electrophoretic migration of the samples, an electric field is applied to the gel layer 702. Under the effect of the field, the samples migrate. As different samples migrate differently, it is possible to identify the sample by their position on the plate. For example, for analysis of a specific protein sample, the information may relate to positive sample identification, i.e., to black regions on the separating layer that is located at a certain distance from the original sample deposition spot. For all identified positives, the information can be sent from the optical reader 901 (FIG. 8) back to the memory device 704. Later this information can be used to remove samples from the identified spots and to transfer them for further analysis, for example by the mass spectrometric techniques.

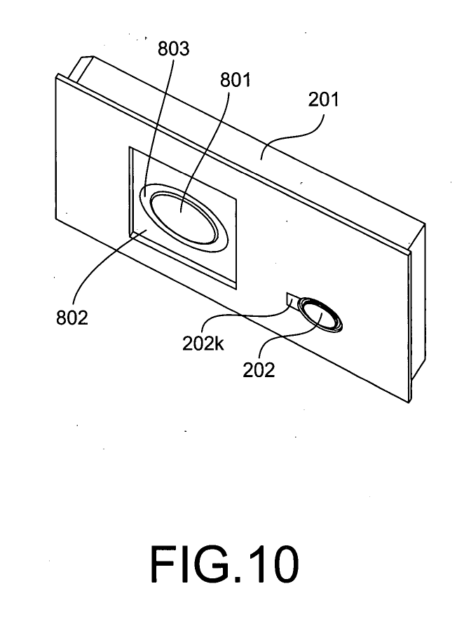

FIG. 10 shows an embodiment of a sample plate which in fact is identical to the sample plate 200 shown in FIG. 3B except that in addition to the memory unit 202 with electrical contacts 202a and 202k, it has a built-in electronic memory 801 having wireless connection to the input/output stations such as the stations 900, 901, etc shown in FIG. 8. The reference number 802 designates a recess for the location of the memory unit 801 in the sample plate body 201. The memory unit is sealed with a protective film 803 that also serves as means for securing the memory unit in place. The wireless connection of the memory unit with the stations allows one to access information without physical contact with the sample plate. As the existing wireless memory units have capacity inferior to those with the physical contact, it may be advantageous to provide the sample plate with both contact and contactless memory devices. An example of a wireless memory unit may be the device produced by HID Corporation, Irvine, Calif., USA (for example models: MicroProx Tag or ProxCard II) with wireless interface built into proximity tags.

While the invention has been described with reference to specific embodiments, the description is illustrative of the invention and is not to be considered as limiting the invention. Various modifications and applications may occur to those skilled in the art without departing from the true spirit and scope of the invention. For example, it is recognized that various electronic memory devices may be used and they may have different read/write interfaces including but not limiting to USB port interfaces (such as an USB memory stick device), flash memory cards (such as flash cards used in the commercial electronic cameras). It is recognized that non-volatile electronic memory used in the present invention may have a final life span (it has to be long enough to provide sufficient time from the beginning to the end of the chip processing and possibly archiving). Also, it is recognized that fully encapsulated electronic memory devices can have certain advantages for the specific applications where aggressive chemicals are present. It is recognized, that different shapes and geometries can be used for the sample plates of the present invention. It is also recognized that sample plates of the invention with built-in memory may be disposable devices. It is recognized that information can be also encoded or encrypted into the electronic memory for the data confidentiality. It is recognized that devices of the present invention can be used along with existing technology such as bar code labels as well as information storage on computer files separately from the sample plates of the present invention. The sample plates of the invention may be used in conjunction with stations other than those described in the specification and their memory chips may store data and commands different from those described above. The system is also applicable for targeted specific chemical or physical chemical modification of samples, e.g., for modifying genes in DNA samples.

1. A system for processing sample plates with built-in electronic memory for high throughput sample processing comprising:
a data input station for loading information into said built-in electronic memory; and at least one sample processing station operating on the basis of information loaded into said data input station;
said sample plate comprising: a sample plate body that carries a plurality of samples; a memory device that is incorporated into said sample plate body, said memory device having data input and data output means for inputting and outputting information related at least to said samples from and into said at least one sample processing station; and means for permanently attaching said memory device to said sample plate body.

2. The system of claim 1, further comprising a loading station for loading a said sample plates with a substance selected from the group consisting of samples and sample processing chemicals.

3. The system of claim 2, further comprising a sample loading station for loading said samples into said sample plates.

4. The system of claim 1, wherein said sample processing station is selected from the group consisting of a mass spectrometer, an optical spectrometer, Raman spectrometer, an infrared spectrometer, a laser-induced fluorescent spectrometer, a chromatographer, a gel electrophoresis analyzer, and a sample filtering station.

5. The system of claim 2, wherein said sample processing station is selected from the group consisting of a mass spectrometer, an optical spectrometer, Raman spectrometer, an infrared spectrometer, a laser-induced fluorescent spectrometer, a chromatographer, a gel electrophoresis analyzer, and a sample filtering station.

6. The system of claim 3, wherein said sample processing station is selected from the group consisting of a mass spectrometer, an optical spectrometer, Raman spectrometer, an infrared spectrometer, a laser-induced fluorescent spectrometer, a chromatographer, a gel electrophoresis analyzer, and a sample filtering station.

7. The system of claim 4, wherein said sample plate is selected from the group consisting of a sample plate with samples permanently attached to said sample plate, a sample plate with wells for retaining liquid samples, a sample plate with through channels for passing liquid samples through said channels, a sample plate with through channels filled with a sample treatment substance, a sample plate with a plurality of nozzles for spraying liquid samples through said nozzles, a sample plate made from light transparent materials for optical treatment of samples, a sample plate with chromatographic coating for chromatographic sample separation, a sample plate with a predeposited array of active spots that possess chemical affinity to specific samples, and a sample plate coated with gel substance for eletrophoretic sample treatment.

8. The system of claim 3, further comprising a plurality of sample plate processing stations and at least one sample plate distribution station for interaction with at least two stations of said plurality for switching the rout of said sample plates between said at least two sample plate processing units.

9. The system according to claim 8, wherein said means for permanently attaching said memory device to said sample plate body is selected from an adhesive connection and a press fit.

10. The system according to claim 7, wherein said means for permanently attaching said memory device to said sample plate body is selected from an adhesive connection and a press fit.

11. The system according to claim 8, wherein said means for permanently attaching said memory device to said sample plate body is selected from an adhesive connection and a press fit.

12. The system according to claim 7, further comprising a security means for preventing access of unauthorized individuals to said information related at least to said samples.

13. The system according to claim 7, wherein said memory device comprises an integrated circuit chip containing a central processing unit, random access memory, and non-volatile data storage.

14. The system according to claim 15, wherein said security means comprises a security information inputted into said non-volatile data storage.

15. The system according to claim 7, further comprising a holding plate that holds said sample plate and said memory device, said sample plate and said memory device being permanently connected to said holding plate.

16. The system according to claim 1, wherein said memory device contains information selected from the group consisting of data on said samples, data on said sample plate, data on preceding, current, and future processes associated with said samples and said sample plate, and commands for processing said samples on current and future processing steps.

17. The system according to claim 7, wherein said memory device contains information selected from the group consisting of data on said samples, data on said sample plate, data on preceding, current, and future processes associated with said samples and said sample plate, and commands for processing said samples on current and future processing steps.

18. The system of claim 6, wherein said sample plate is selected from the group consisting of a sample plate with samples permanently attached to said sample plate, a sample plate with wells for retaining liquid samples, a sample plate with through channels for passing liquid samples through said channels, a sample plate with through channels filled with a sample treatment substance, a sample plate with a plurality of nozzles for spraying liquid samples through said nozzles, a sample plate made from light transparent materials for optical treatment of samples, a sample plate with chromatographic coating for chromatographic sample separation, a sample plate with a predeposited array of active spots that possess chemical affinity to specific samples, and a sample plate coated with gel substance for eletrophoretic sample treatment.

19. The system of claim 18, further comprising a plurality of sample plate processing stations and at least one sample plate distribution station for interaction with at least two stations of said plurality for switching the rout of said sample plates between said at least two sample plate processing units.

20. The system of claim 17, further comprising a plurality of sample plate processing stations and at least one sample plate distribution station for interaction with at least two stations of said plurality for switching the rout of said sample plates between said at least two sample plate processing units.

21. A method for processing a plurality of samples supported by sample plates with built-in electronic memory comprising a data input station for loading information into said built-in electronic memory, and at least one sample processing station operating on the basis of information loaded into said data input station, wherein said sample plate comprises a sample plate body that carries a plurality of samples, a memory device that is incorporated into said sample plate body, said memory device having data input and data output means for inputting and outputting information related at least to said samples from and into said at least one sample processing station, and means for permanently attaching said memory device to said sample plate body, said method comprising the steps of:
loading said samples on said sample plate;
inputting into said built-in electronic memory information selected from the group consisting of data on said samples, data on said sample plate, data on preceding, current, and future processes associated with said samples and said sample plate, and commands for processing said samples on current and future processing steps; and
processing said sample plates in accordance with information selected from said group.

22. The method of claim 21, wherein said step of loading said samples on said sample plate is interlocked with said step of inputting said information into said memory device for carrying out said both steps simultaneously.

23. The method of claim 21, wherein said step of processing said sample plates comprises processes selected from analyzing said samples, handling said sample plates, loading said samples into said sample plates, passing said samples through said sample plates, inputting data into said memory device, retrieving data from said memory device, treating said samples chemically, and treating said samples with a light.

24. The method of claim 23, wherein said step of analyzing is carried out with the use of an analyzer selected from the group consisting of a mass spectrometer, an optical spectrometer, Raman spectrometer, an infrared spectrometer, a laser-induced fluorescent spectrometer, a chromatographer, a gel electrophoresis analyzer, and a sample filtering station.
